(19) United States
(12) Patent Application Publication
(10) Pub. No.: US 2026/0092576 A1
(43) Pub. Date: Apr. 2, 2026

(54) HOT-GAS FREE-PISTON STIRLING ENGINE WITH EFFICIENT HOT AIR INLET

(71) Applicant: EXOWATT, INC., Miami, FL (US)

(72) Inventors: Sushrut Bapat, Miami, FL (US); Pedro Neves, Miami, FL (US); Kiran Kambly, Miami, FL (US); Ehsan Ordouie, Miami, FL (US); Hannan Parvizian, Miami, FL (US); John M DeLappe, Miami, FL (US); SeonYoung Kim, Miami, FL (US); Christopher Rengifo, Miami, FL (US); Simon Shuham, Miami, FL (US)

(21) Appl. No.: 19/308,157

(22) Filed: Aug. 22, 2025

Related U.S. Application Data
(60) Provisional application No. 63/686,611, filed on Aug. 23, 2024.

(51) Int. Cl. F02G 1/043; F02G 1/053; F02G 1/055; F02G 1/057

(52) U.S. Cl. CPC F02G 1/0435; F02G 1/055; F02G 1/057; F02G 1/0535; F02G 2254/05; F02G 2255/10; F02G 2257/00; F02G 2270/005; F02G 2280/10

(57) ABSTRACT

A new thermal engine design and novel hot air inlet provide a high-efficiency hot-gas free-piston Stirling engine design.

### CROSS-REFERENCES TO RELATED APPLICATIONS

Benefit is claimed from U.S. Provisional Patent Application No. 63/686,611 filed Aug. 23, 2024, which is incorporated herein by reference in its entirety and for all purposes.

### STATEMENT REGARDING FEDERALLY SPONSORED RESEARCH OR DEVELOPMENT

None.

### FIELD

The technology herein relates to thermal engines, and more particularly to a hot gas linear free-piston Stirling or other thermal engine configured for converting collected solar or other heat into mechanical energy and/or electricity. The technology further relates to hot air inlets for Stirling and other thermal engines.

### BACKGROUND AND SUMMARY

We are all familiar with internal combustion piston engines that take in a fuel-air mixture and burn the mixture internally to produce hot expanding gases. The hot expanding gases apply force to move one or more power pistons to generate mechanical power. The hot gases are then expelled from the engine through an exhaust system—generating pollution such as smog.

There is another kind of piston engine called a thermal or heat engine that moves the piston based on hot expanding gas heated by externally-applied heat. Such a thermal or heat engine does not expel the hot gases but instead cools and recycles them internally without releasing them to pollute the surrounding air.

One such type of thermal or heat engine is a “Stirling engine”—named after Robert Stirling who invented a thermodynamic closed cycle in the early 19th century as a potential alternative to steam engines.

A Stirling engine is a kind of heat engine operated by the cyclic compression and expansion of air or other gas (the working fluid) between different temperatures, resulting in a net conversion of heat energy to mechanical work. See e.g., Walker, “Stirling Engines” (Clarendon Press, Oxford 1980); W. R. Martini, “Stirling Engine Design Manual” (2d Ed. NASA 1983). The Stirling engine is a closed-cycle heat engine—meaning a thermodynamic system in which the working fluid is permanently contained within the system. As noted below, the Stirling engine's internal “regenerator” heat exchanger and thermal store retains heat from one cycle to the next.

In a Stirling engine, a working fluid such as a gas is heated and expanded due to thermal energy supplied from outside the engine. The gas then flows to a different location within the engine where it is cooled and compressed. A piston (or pistons) moves the gas to the correct places within the engine, at the correct time in the cycle, and extracts mechanical power from this motion. The gas alternates between these heating and cooling cycles, changing temperature and pressure as it goes. A regenerator acts as a temporary heat store by retaining heat within the engine rather than dumping it into the environment, thereby increasing its efficiency. There are no intake and no exhaust gas flows so the engine is practically silent. See e.g., //en.wikipedia.org/wiki/Stirling_engine#Theory

While Stirling engines have in the past enjoyed only limited, specialized application, there is renewed interest in Stirling engines for use in or with renewable energy sources such as solar energy collection. See e.g., Kongtragool et al, “A review of solar-powered Stirling engines and low temperature differential Stirling engines” Renewable and Sustainable Energy Reviews Volume 7, Issue 2, Pages 131-154 (April 2003); Singh, “Review on solar Stirling engine: Development and performance”, Thermal Science and Engineering Progress Volume 8, Pages 244-256 (December 2018); Taki et al, “A Study of Stirling Engine Efficiency Combined with Solar Energy”, Advances in Science, Technology and Engineering Systems Journal Vol. 6, No. 2, 837-845 (2021).

There are a few commercial Stirling engine designs available in market. The Microgen Engine Corporation (MEC) Free Piston Stirling engine (see e.g., U.S. Pat. No. 6,983,593 and www.microgen-engine.com/technology/) has a Stirling cycle efficiency listed at 26%. Frauscher Motors GmbH has a hot-air engine measured efficiency of 22%. See e.g., https://frauscher-motors.com/alphagamma-technology/.

Higher efficiency thermal, heat and Stirling engine designs are therefore desired. In particular, such engine designs that operate based on hot gases produced by solar collection would fulfill a long felt but unsolved need.

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 shows in cross-section an example thermal engine system including a hot gas inlet and associated heat exchanger thermally coupled to a thermal engine.

FIG. 2 shows a cutaway view of an example thermal engine with a finned hot gas inlet structure in place.

FIG. 2A shows an example hot air inlet with inlet manifold removed to expose internal fins.

FIG. 2B shows an example exploded view of the hot air inlet and the thermal engine.

FIG. 2C shows a detailed view of an example hot air inlet finned structure.

FIG. 3A shows the example thermal engine and example hot air inlet coupled together with see-through to internal parts/structures shown in cross-section.

FIG. 3B shows another exploded view of the thermal engine including hot air inlet from a perspective that is slightly rotated as compared to FIG. 2B.

FIG. 4 shows a cutaway view of the example thermal engine with the hot gas inlet removed.

FIG. 5 shows an outer view of the thermal engine.

FIGS. 6A & 6B show different views of the example thermal engine with its top casing in place but with the hot gas inlet removed.

FIGS. 7A, 7B, show different external views of a thermal engine.

FIGS. 8A, 8B show different external views of a thermal engine casing and form factor.

### DETAILED DESCRIPTION OF EXAMPLE NON-LIMITING EMBODIMENTS

Embodiments provide a hot-gas, free-piston thermal (e.g., Stirling) engine design including a hot gas inlet providing a high-efficiency external heat-exchanger, an engine head chamber design, and a new overall engine design as a whole. The new design has unique dimensions of overall parts that when combined together give higher efficiencies (e.g., at least a 30% efficient Stirling engine design) and power output and can operate from applied hot gases such as hot air produced by a solar collector or other heat source(s). The design also has custom size and custom features. The novel hot gas inlet can be used in contexts including but not limited to thermal engines.

A thermal engine substantially as shown and described, includes a piston reciprocating within a chamber, the piston operating according to the Stirling principle, and a conical/cylindrical hot gas inlet that acts as heat exchanger. The hot gas inlet is coupled to a thermal head of the thermal engine and is configured to receive heated gas, absorb heat carried by the gas and to transfer the absorbed heat from the heated gas to the thermal engine in order to operate the thermal engine.

A hot gas inlet substantially as shown and described, comprises a conical/cylindrical structure that receives hot gas and distributes the received hot gas across an array of high temperature heat-conductive fins forming a heat exchanger. The conical/cylindrical heat exchanger comprises an array of high temperature heat-conductive fins positionally radiating or extending from a central cavity. The central cavity is shaped, configured and dimensioned to accept and encase the heat of the thermal engine. A shroud comprising a conical portion and a cylindrical portion receives the hot gas flow and distributes the hot gas flow so the hot gas flows through the spaces between the fins. The fins are thermally coupled to an internal heat exchanger within a thermal head of the thermal engine. The conical/cylindrical hot gas inlet is configured to receive heated gas and to transfer heat from the heated gas to the thermal engine head in order to operate the thermal engine.

An embodiment comprises a thermal engine comprising an engine head defining an internal cylindrical cavity therein and further defining a thermal head; a piston reciprocatable within the internal cylindrical cavity according to the Stirling principle, a spring connected to the piston, the spring storing and providing energy for continual reciprocation of the piston; and a conical heat exchanger thermally coupled to the thermal head, the conical heat exchanger configured to receive a flow of first working fluid originating externally to the thermal engine and to transfer heat from the first working fluid flow to the thermal head and thereby to second working fluid within the internal cylindrical cavity, to thereby cause the piston to recirculate within the internal cylindrical cavity according to the Stirling principle.

The piston has disposed thereon a gas seal formed by a network of micro-grooves disposed on an outer cylindrical surface of the piston adjacent to a crown of the piston, the network of micro-grooves lubricating and sealing the piston outer cylindrical surface to the internal cylindrical cavity without requiring a sealing piston ring.

A regenerator surrounding a portion of the internal cylindrical cavity may be provided.

The internal cylindrical cavity terminates in the thermal head comprising a dome-shaped structured enclosing an end of the internal cylindrical cavity.

A displacer may be disposed within the internal cylindrical cavity, the displacer being mechanically coupled to move in response to reciprocation of the piston.

A linear generator element may be connected to the piston, the linear generator elements converting linear piston reciprocation to electrical current.

The thermal engine may comprise a cylindrical capped structure and the conical heat exchanger is removably disposed onto the thermal head cylindrical capped structure.

The conical heat exchanger may comprise a plurality of coaxial, concentric heat exchange fins.

A displacer and the piston coaxially reciprocate.

An embodiment of a conical heat exchanger configured for coupling to a thermal head, the conical heat exchanger configured to receive heated working fluid and to transfer heat from the heated working fluid to the thermal head, the conical heat exchanger comprising a plurality of fins projecting concentrically from a cylindrical cavity defined therein, the plurality of fins comprising side peripheral edges and top peripheral edges, the cylindrical cavity being dimensioned and configured to surround the thermal head; a cylindrical collar shroud disposed around the side peripheral edges of the plurality of projecting fins, the cylindrical shroud defining at least one air opening therethrough; and a truncated conical cap flow-coupled to the top peripheral edges of the plurality of fins to flow working fluid through interstices between the plurality of fins, wherein in use the working fluid flows through the truncated conical cap, the interstices between the fins, and cylindrical collar shroud at least one air opening.

The thermal head comprises a cylindrical thermal head of a Stirling engine cylinder.

The plurality of fins comprise a plurality of stacked cylindrical fin layers.

The truncated conical cap defines a circular working flow opening at an apex end thereof.

The cylindrical collar shroud surrounds the side peripheral edges of the plurality of fins and seals to the truncated conical cap.

The plurality of fins comprise high-temperature resistant, heat-conductive plates.

A portion of the plurality of fins comprises a regenerator.

The cylindrical collar shroud defines a plurality of working fluid openings spaced apart about a circumference thereof.

The cylindrical collar shroud defines a single working fluid opening therethrough.

### Example Thermal Engine With Hot Gas Inlet

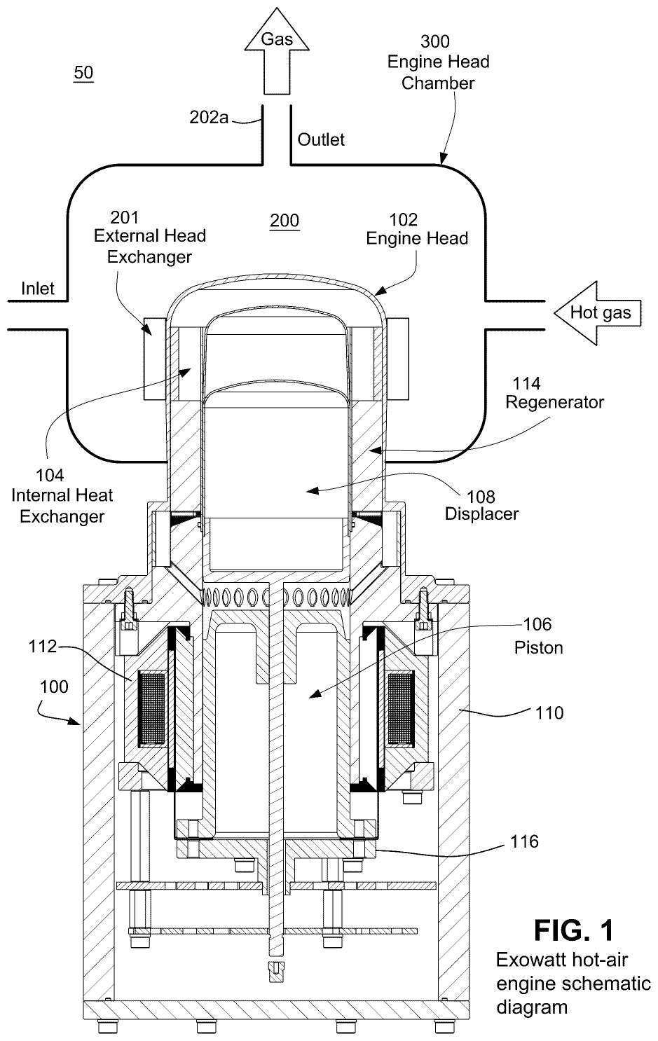

FIG. 1 shows an example hot-gas free-piston thermal engine system 50 comprising an efficient hot gas inlet 200 coupled to a thermal engine 100. A thermal collection and/or production system such as a solar collector(s) (not shown) supplies heated or hot gas such as air or other heated gaseous medium/media to the hot gas inlet 200. In one embodiment, the thermal collection system collects heat from solar energy and produces a stream of hot gas (e.g., air) that is fluid-coupled to the hot gas inlet 200. The hot gas inlet 200 transfers the heat from the heated gas to the engine head 102 of thermal engine 100.

In one example, the hot gas inlet 200 includes an external (of the thermal engine 100) heat exchanger 201 thermally coupled to an internal (of the thermal engine 100) heat exchanger. The external heat exchanger 201 supplies heat the hot gas inlet 200 obtains from hot gas circulating therethrough, to the thermal engine's internal heat exchanger 104 which is part of the thermal engine 100's engine head 102.

The engine head 102 receives and applies the transferred heat to internal parts of the thermal engine 100 in order to operate the thermal engine. In one example, thermal engine 100 may comprise a single cylinder Stirling engine including a reciprocating piston 106 that is mechanically coupled to and/or part of an electrical generator. In example embodiments, system 50 converts heat externally supplied by the heated gas into mechanical power/movement and from mechanical power/movement into electricity, discharging the heated gas without combusting it or otherwise using it up so it can be recirculated/reheated. In the example system shown, there are two working fluids:
a first working fluid that carries heat to the engine 100 via inlet 200; and
a second working fluid inside the engine 200 that when heated by the heat transferred to the engine from the first working fluid, causes displacer 106 to reciprocate and thereby generate mechanical power.

The second working fluid is trapped inside engine 100 and is not released or used up—it is simply recirculated/recycled within the engine. The first working fluid meanwhile never enters the closed system of engine 100, but rather passes through the hot air inlet structure 100 and serves as an energy transfer medium to transfer (input) heat to the engine 100. The hot air inlet 200 could be considered to be part of engine 100, in which case the engine could then comprise an open working fluid portion for the first working fluid, and a closed working fluid portion for the second working fluid. In such a design, the first working fluid and the second working fluid do not mix with one another—they are contained in separate circulation circuits or paths, with a working fluid impermeable heat transfer or heat exchanger structure disposed between them.

### Example Embodiment Hot Gas Inlet 200

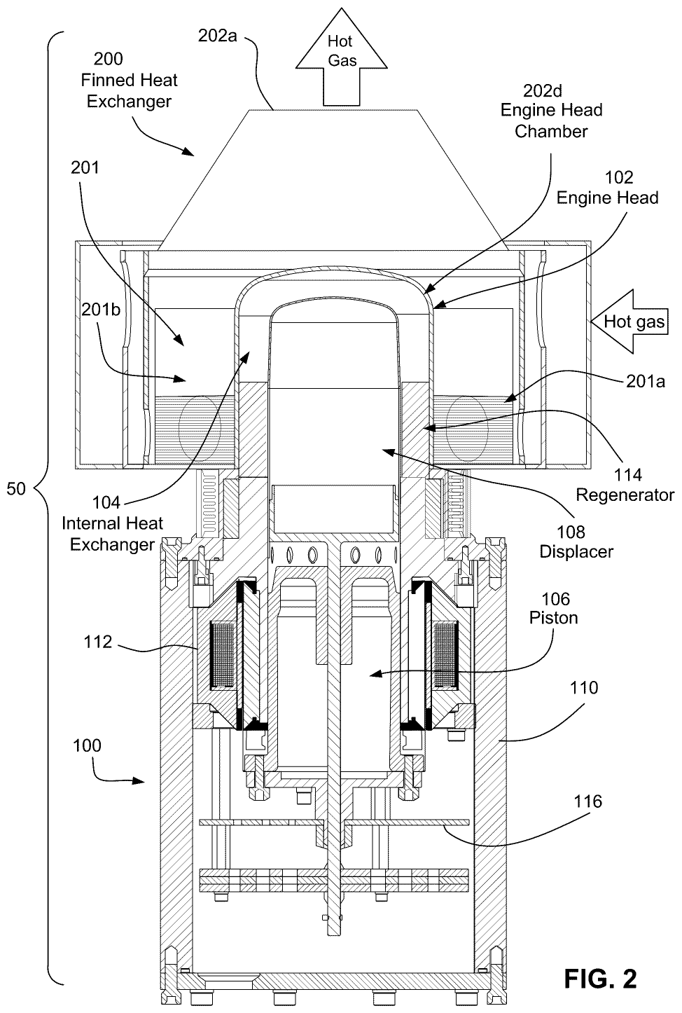

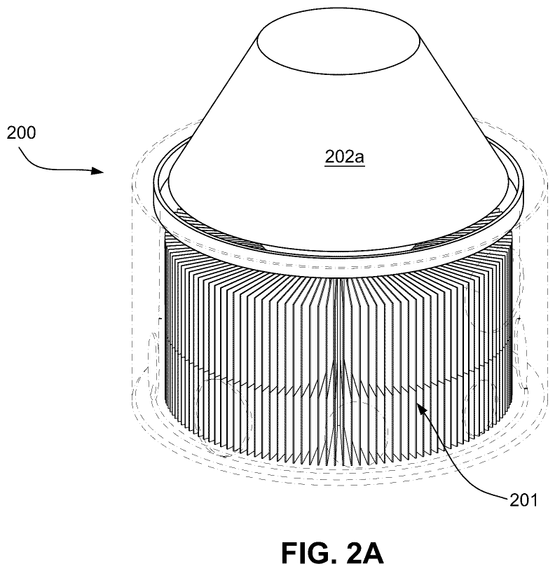

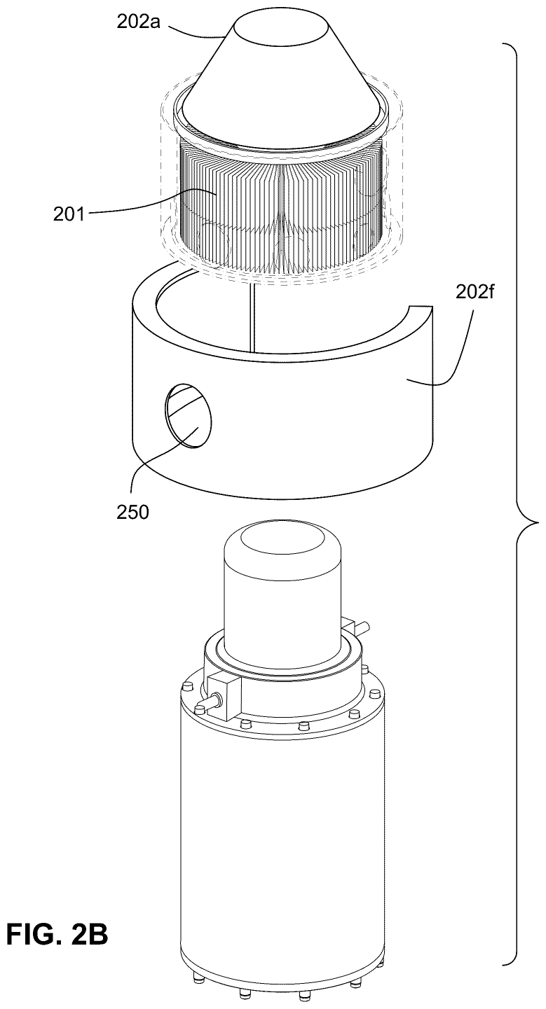

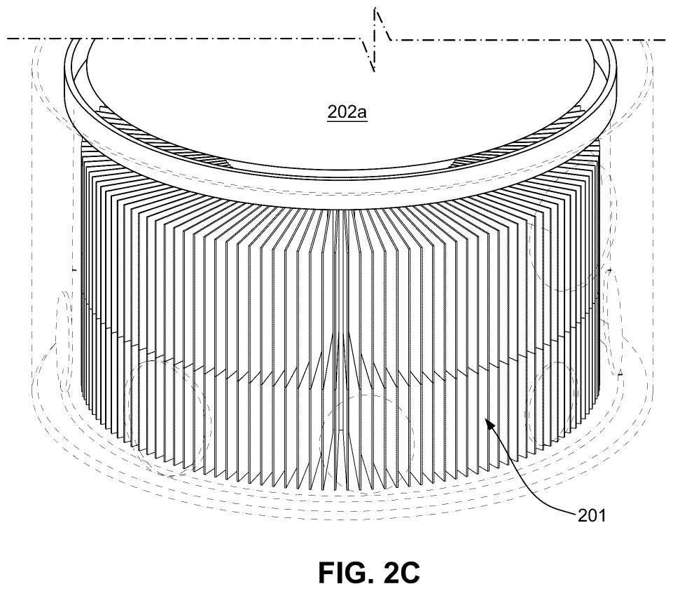

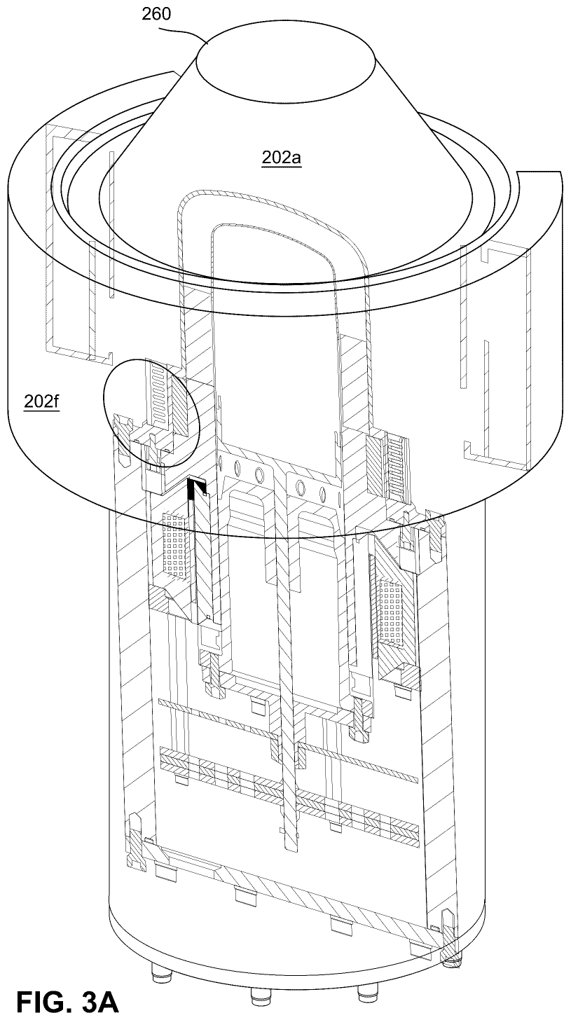

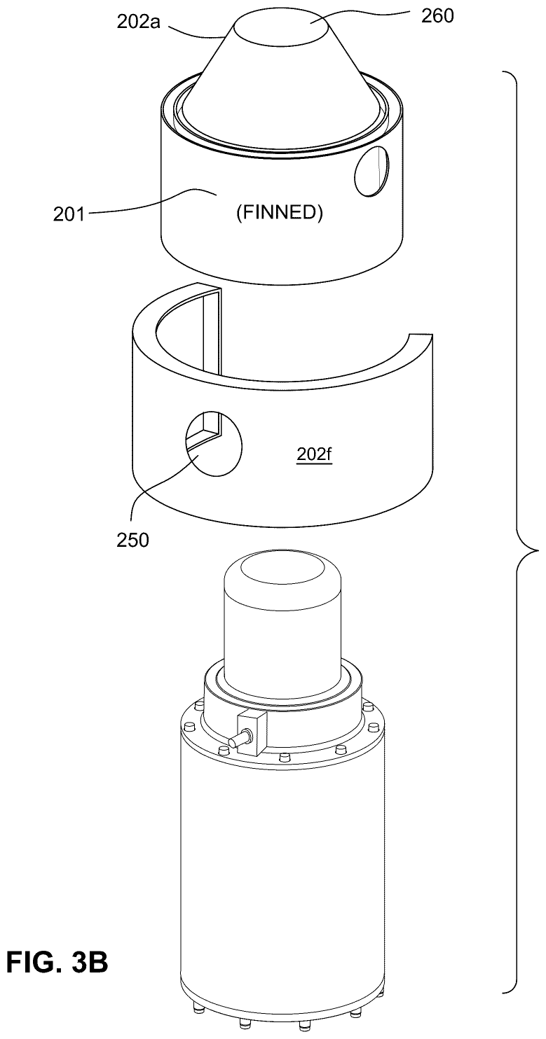

FIGS. 2, 2A, 2B, 2C, 3A, 3B show different views of an example embodiment hot gas inlet 200 comprising an array of spaced-apart heat-conductive high temperature fins 201 (shown in cross-section in FIG. 2) arranged radially extending from a central cavity encapsulating at least a portion of engine head 102. In one example embodiment seen best in FIG. 2A, 2B, the hot gas inlet 200 comprises three parts:
an array 201 of radially extending fins surrounded by
a gas inlet manifold collar 202f extending around the outer peripheries of the fins, and topped by
a conical discharge manifold 202a.

Hot gas enters the gas inlet manifold collar 202f through one or more inlet ports 250. There can be one or more than one inlet port 250. The gas inlet manifold collar 202f distributes the hot gas around the peripheries of the fins 201 to cause the gas to flow between the fins from the peripheries of the fin inwardly and upwardly (in the orientations shown) into the conical discharge manifold 202a. The conical discharge manifold 202a gathers the various substreams of hot gas flowing between each adjacent pair of fins into a common discharge flow that is discharged through a discharge port 260 at an end of the cone having a smaller(est) circumference.

Fins 201 may comprise or consist of a thermally conductive high temperature material such as metal (e.g., copper, aluminum, stainless steel, etc.). Each of a plethora of fins 201 may be or comprise a thin metallic plate or metallic wire shape that is spaced apart from adjacent fins and is thermally coupled to the external heat exchanger 201 structure shown schematically in FIG. 2 (this structure may comprise the ends of the fins where they contact the external circumferential surface of the thermal engine head 102). The fins 201 can be made of a high thermally conductive material that does not degrade when exposed to the working fluid that passes through the hot inlet 200. For example, when the working fluid is hot air, the fins 201 can be made of copper, aluminum, or high temperature steel, depending on working fluid temperature. Working fluid temperature, in turn, is controlled based on the heat requirements of the thermal engine 100 (see discussion below).

As best seen in FIG. 2A, 2C, the fins 201 in one embodiment may have a common size/shape/profile and extend radially outwardly from a center cavity, with a predetermined spacing defined between adjacent fins. As noted above, this spacing provides respective passageways for a heated working fluid such as a gaseous medium to be blown or otherwise transported through the inlet structure without significant resistance, to allow high gas flow rates while at the same time retaining the heated gaseous medium within the hot air inlet for a sufficient transit distance to allow efficient and effective transfer of a significant amount of heat from the heated gaseous medium to the heat-conductive structures of the inlet fins 201.

For example, as hot gas passes between the fins 201, the fins remove heat from the hot gas and thermally couple that heat to a thermally-coupled internal heat exchanger 104 within the thermal engine that acts as a heat “sponge” that heats up and holds thermal energy within the thermal engine and transfers heat to the working fluid within the engine.

Hot air can be provided by blowers to gas inlet 200 via one or more inlet ports 250 of inlet manifold 202f for circulation through the fins 201 to discharge port 260 so the external heat exchanger 201 is continually conducting heat from a heated gaseous or other medium for application to the thermal engine to keep the thermal engine continually operating. Hot air injected under pressure into heat-resistant inlet manifold collar 202f circulates through the hot gas inlet 200 (i.e., flowing between spacings between the heat-conductive plates) and after giving up some of its heat to the fins 201, is gathered by the conical discharge structure 202a. The cooler air flowing out of the heat exchanger discharge port(s) 260 can be recirculated through a heat source such as a solar collector to thereby reheat the air and recirculate it through the heat inlet 200, to avoid releasing excess heat to the environment. Other embodiments do not necessarily recirculate but may instead continually receive “new” (unrecirculated) hot air from a heat source.

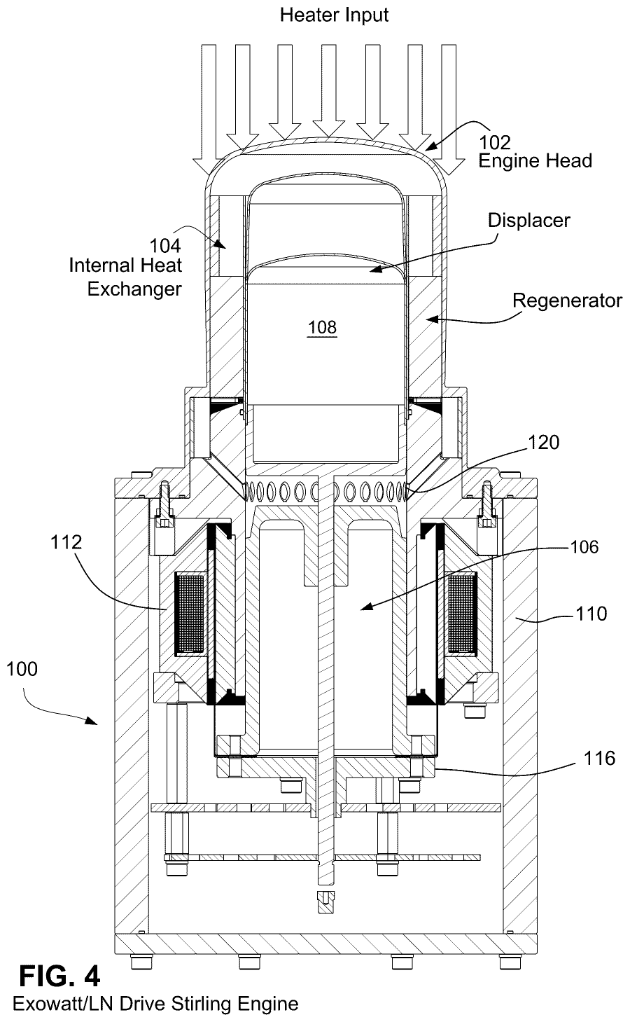

In one embodiment shown in FIGS. 1-3, the hot gas inlet 200 is thermally coupled to transfer heat to an internal heat exchanger 104 that is part of a head 102 of the thermal engine 100. Thermal engine head 102 may comprise a fully-insulated chamber (see FIG. 4) having a head conductive exterior surface that is thermally coupled to the fins 201 of external hot gas inlet 200. In one embodiment, the hot gas inlet 200 and internal heat exchanger 102 are separate structures that are thermally coupled together such as shown in the FIG. 3B exploded view, with hot gas inlet 200 sliding over the internal heat exchanger 102.

### Example Thermal Engine 100 Design

The thermal engine 100 in one embodiment is a free-piston single cylinder Stirling engine with helium as a working fluid (this can be a different working fluid as compared to the working fluid that flows through the hot inlet 200 as described above). The engine head 102 (which may comprise stainless steel) accepts heat from the hot gas inlet 200 and delivers the heat to the working fluid within the engine using an internal heat exchanger 104 which forms a domed engine head chamber 300 within the engine (see FIG. 4). Working fluid is helium in one embodiment, but can be hydrogen, air or any other gas or combination of gases. The working fluid increases its temperature and subsequently its pressure. It then expands isothermally to drive a power piston 106 downward, thereby creating mechanical energy. This mechanical energy can move magnets or electromagnets relative to coils to produce electricity.

In one example, a displacer 108 is positioned between the power piston 106 and the domed chamber 300 within the same cylinder as the piston 106 is disposed in. In this example embodiment, the Stirling engine is a β type and the displacer 108 and the piston 106 share the same cylinder. The displacer piston's primary function is to move the working gas between hot and cold heat exchangers. The displacer 108 moves up and down (reciprocates) in the example shown to displace the helium or other working fluid from the hot end (top) of the cylinder to the cold end (bottom) and vice versa. The role of the displacer 108 is thus to move, or displace, working fluid in the engine between a heated upper region and the cooled region.

In the example shown, the piston 106 and the displacer 108 are linked together such that their movements are 90° out of phase. That is, when the power piston 106 is either at its maximum or minimum height and moving slowly, the displacer 108 is at its halfway point and moving at its maximum speed (and vice versa).

When displacer 108 is in the lower cold region, this forces the working gas to occupy the upper hot region. The internal heat exchanger 104 adds heat to the gas and the gas expands—forcing the power piston 106 to move downwards.

The power piston 106 moves more slowly when it is at its lowermost position (the heated gas has its maximum volume). The displacer 108, on the other hand, is moving upward into the hot region causing the gas to move from the upper hot region to the lower cold region.

In this design, a regenerator 114 is disposed around the displacer 108. Regenerator 114 stores heat from one cycle so it can be used in the next cycle. The regenerator 114 is made of a material that can withstand high temperatures that are coupled to the engine 100. Thus, when the displacer 108 is moving upwards to move the working fluid from the hot region to the cold region, the working fluid flows past the regenerator 114 and gives up some of its heat to the regenerator (so the regenerator temporarily stores energy taken from the gas as it cools). One skilled in the art understands that the temperature differential between the working fluid in the hot region and the working fluid in the cold region is instrumental to making the Stirling engine function and function efficiently. To this purpose, the engine 100 contains a cold end heat exchanger 120 that maintains the cold end at some desired temperature such as for example 60 deg C., to create a suitable temperature differential (ΔT) between the cold end or region of the engine cylinder and the hot end or region of the engine cylinder.

Once most or all of the gas is in the cold region, it contracts (because heat has been removed from the gas) causing the power piston 106 to begin to move upwards (in this example, a spring arrangement 116 also causes the piston to move upwards after being forced downward by the hot expanded working fluid to its lowermost position, eliminating the need for a flywheel). A unique shape of the spring 116 and dimensions provide a piston 106 with the spring back force.

The power piston 106 moves more slowly as it nears a maximum upward position to define a minimum volume within the cylinder. The displacer 108 is meanwhile moving downwards, forcing the gas to move from the cold region into the hot region. As the cool gas passes by the regenerator 114, the gas recovers some of the heat that was in the last cycle temporarily stored in the regenerator. The gas now in the upper hot region absorbs more heat from the internal heat exchanger 104. The state of the Stirling engine 100 has thus returned to its initial described state and a new cycle starts. The Stirling cycle repeats indefinitely so long as external heat continues being supplied.

In one embodiment, the bottom section 110 of the engine 100 contains a linear alternator 112—an electromechanical component that converts the oscillating motion of the piston 106 to electrical energy. In other embodiments, an electrical, electromechanical or mechanical component(s) can be mechanically coupled to a piston rod to move with the piston 106.

The engine design contains a gas seal that is formed by a network of micro-grooves. The microgrooved gas seal eliminates need for piston rings that need oil for lubrication. The gas seal performs the function of the lubricant and the sealant and therefore reduces complexity and maintenance burden.

In one embodiment, a cylinder liner is used to protect the displacer 108 and seal the piston 106. In one embodiment, the gas seal maintains a pressure of e.g., 500 PSI within the cylinder so the working fluid internal to the Stirling engine does not escape.

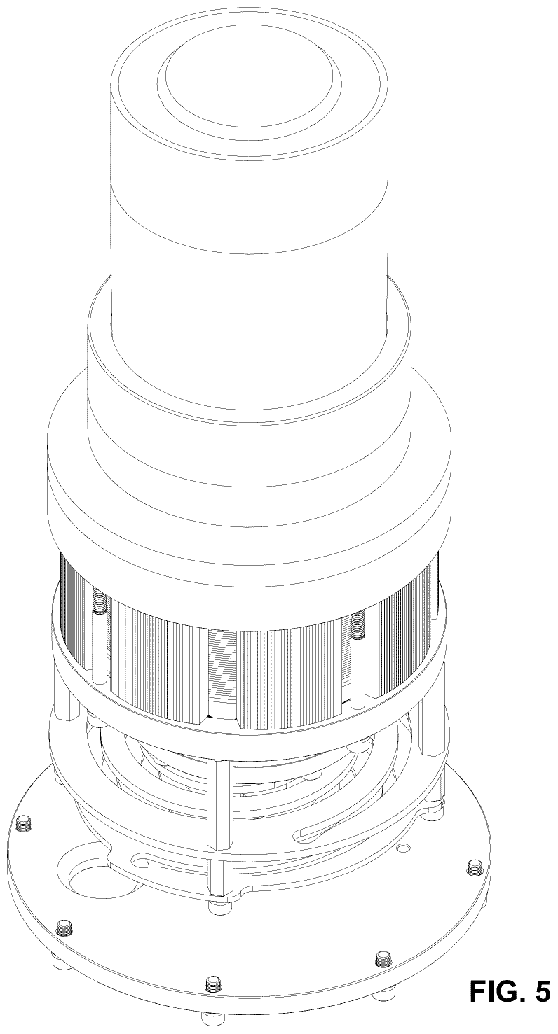

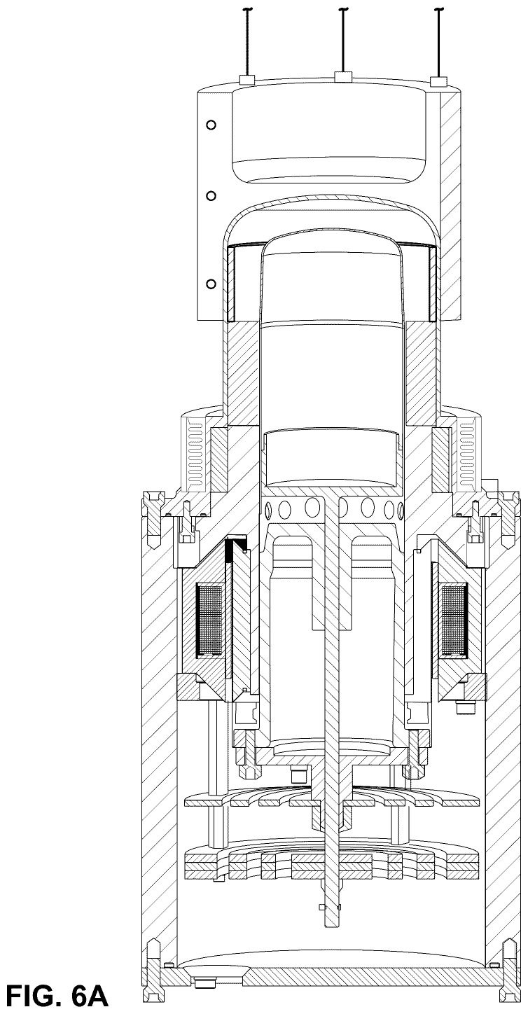

FIG. 5 shows an example outer form factor for the Stirling engine which is adapted to accept and support the external heat exchanger.

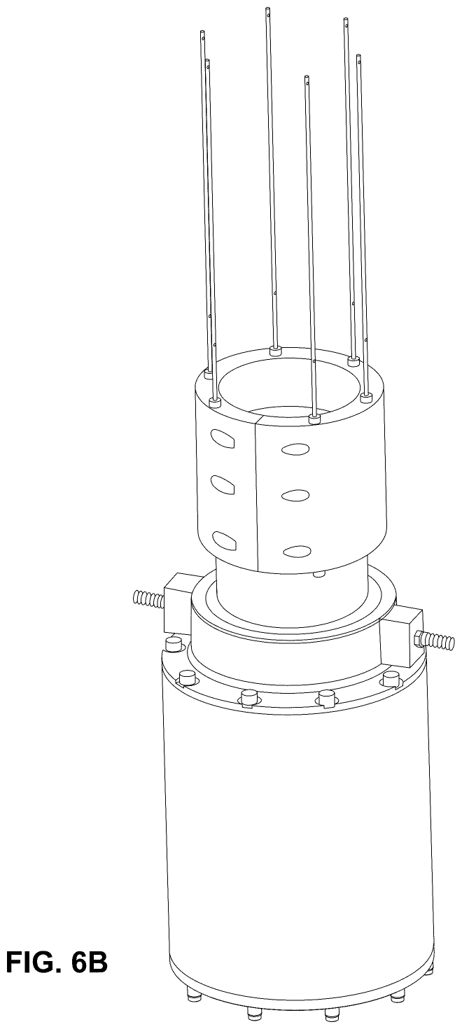

FIGS. 6A and 6B show external views of an embodiment of the engine with a different heat exchanger head.

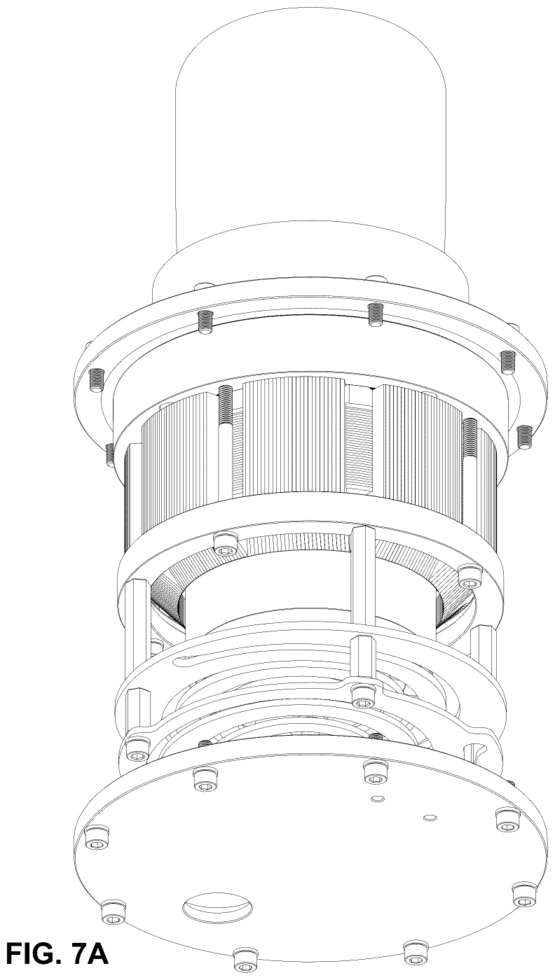

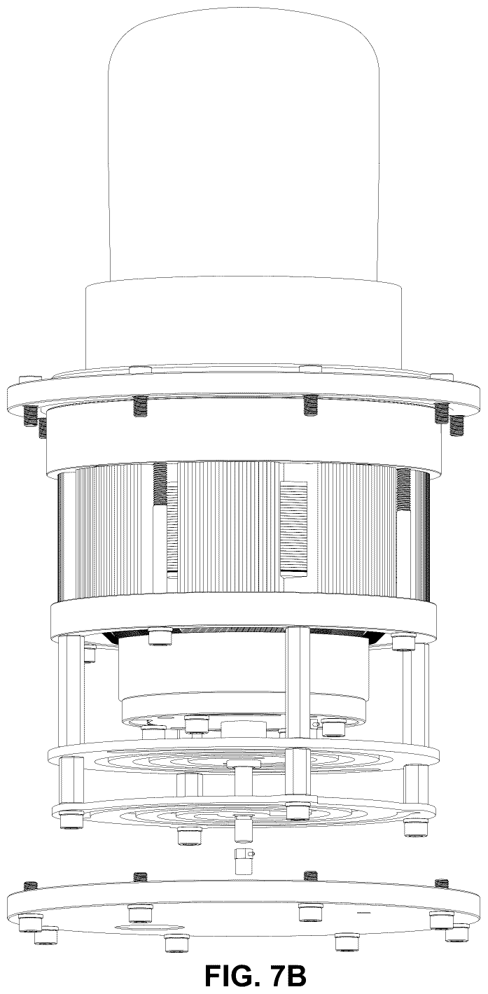

FIGS. 7A & 7B show external views of the example engine with external heat exchanger head and outer casing removed.

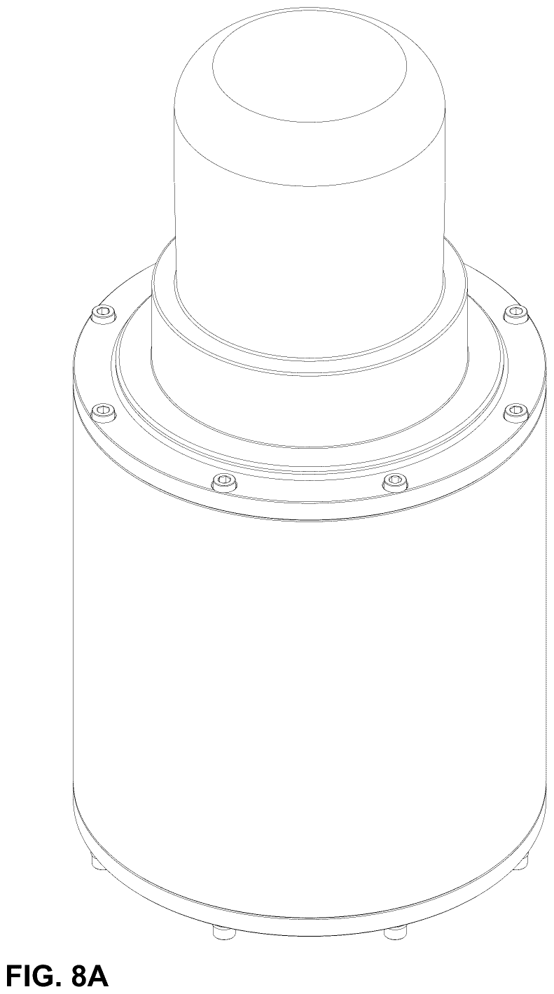

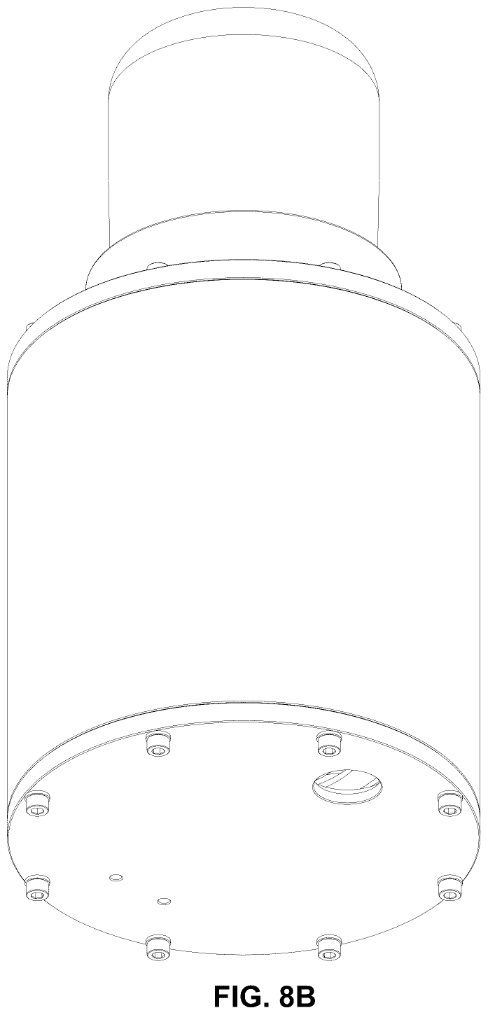

FIGS. 8A & 8B show an example engine embodiment with an external protective case in place.

All patents and publications cited herein are incorporated by reference.

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

We claim:

1. A thermal engine comprising:
an engine head defining an internal cylindrical cavity therein and further defining a thermal head;
a piston reciprocatable within the internal cylindrical cavity according to the Stirling principle,
a spring connected to the piston, the spring storing and providing energy for continual reciprocation of the piston; and
a conical heat exchanger thermally coupled to the thermal head, the conical heat exchanger configured to receive a flow of first working fluid originating externally to the thermal engine and to transfer heat from the first working fluid flow to the thermal head and thereby to second working fluid within the internal cylindrical cavity, to thereby cause the piston to recirculate within the internal cylindrical cavity according to the Stirling principle.

2. The thermal engine of claim 1 wherein the piston has disposed thereon a gas seal formed by a network of micro-grooves disposed on an outer cylindrical surface of the piston adjacent to a crown of the piston, the network of micro-grooves lubricating and sealing the piston outer cylindrical surface to the internal cylindrical cavity without requiring a sealing piston ring.

3. The thermal engine of claim 1 further comprising a regenerator surrounding a portion of the internal cylindrical cavity.

4. The thermal engine of claim 1 wherein the internal cylindrical cavity terminates in the thermal head comprising a dome-shaped structured enclosing an end of the internal cylindrical cavity.

5. The thermal engine of claim 1 further comprising a displacer disposed within the internal cylindrical cavity, the displacer being mechanically coupled to move in response to reciprocation of the piston.

6. The thermal engine of claim 1 further including a linear generator element connected to the piston, the linear generator elements converting linear piston reciprocation to electrical current.

7. The thermal engine of claim 1 wherein the thermal engine comprises a cylindrical capped structure and the conical heat exchanger is removably disposed onto the thermal head cylindrical capped structure.

8. The thermal engine of claim 7 wherein the conical heat exchanger comprises a plurality of coaxial, concentric heat exchange fins.

9. The thermal engine of claim 1 wherein a displacer and the piston coaxially reciprocate.

10. A conical heat exchanger configured for coupling to a thermal head, the conical heat exchanger configured to receive heated working fluid and to transfer heat from the heated working fluid to the thermal head, the conical heat exchanger comprising:
a plurality of fins projecting concentrically from a cylindrical cavity defined therein, the plurality of fins comprising side peripheral edges and top peripheral edges, the cylindrical cavity being dimensioned and configured to surround the thermal head;
a cylindrical collar shroud disposed around the side peripheral edges of the plurality of projecting fins, the cylindrical shroud defining at least one air opening therethrough; and
a truncated conical cap flow-coupled to the top peripheral edges of the plurality of fins to flow working fluid through interstices between the plurality of fins,
wherein in use the working fluid flows through the truncated conical cap, the interstices between the fins, and cylindrical collar shroud at least one air opening.

11. The conical heat exchanger of claim 10 wherein the thermal head comprises a cylindrical thermal head of a Stirling engine cylinder.

12. The conical heat exchanger of claim 10 wherein the plurality of fins comprise a plurality of stacked cylindrical fin layers.

13. The conical heat exchanger of claim 10 wherein the truncated conical cap defines a circular working flow opening at an apex end thereof.

14. The conical heat exchanger of claim 10 wherein the cylindrical collar shroud surrounds the side peripheral edges of the plurality of fins and seals to the truncated conical cap.

15. The conical heat exchanger of claim 10 wherein the plurality of fins comprise high-temperature resistant, heat-conductive plates.

16. The conical heat exchanger of claim 10 wherein a portion of the plurality of fins comprises a regenerator.

17. The conical heat exchanger of claim 10 wherein the cylindrical collar shroud defines a plurality of working fluid openings spaced apart about a circumference thereof.

18. The conical heat exchanger of claim 10 wherein the cylindrical collar shroud defines a single working fluid opening therethrough.
